(19) United States
(12) Patent Application Publication
(10) Pub. No.: US 2014/0060481 A1
(43) Pub. Date: Mar. 6, 2014

(54) METHOD AND APPARATUS OF PRODUCING LAMINAR FLOW THROUGH A FUEL INJECTION NOZZLE

(71) Applicant: Robert D. Straub, Lowell, MI (US)

(72) Inventor: Robert D. Straub, Lowell, MI (US)

(73) Assignee: GM GLOBAL TECHNOLOGY OPERATIONS LLC, Detroit, MI (US)

(21) Appl. No.: 13/597,747

(22) Filed: Aug. 29, 2012

(51) Int. Cl. F02B 3/00

(52) U.S. Cl. 123/294; 137/1

(57) ABSTRACT

A method and apparatus for producing laminar flow through a fuel injection nozzle are provided. The method may comprise the steps of: providing a housing defining a cavity; providing a nozzle assembly having a first portion and a second portion extending from the first portion, the nozzle assembly being disposed within the cavity; placing the nozzle assembly in a closed position wherein the nozzle assembly is engaged with a valve seat defined by the housing; displacing the nozzle assembly and moving the nozzle assembly in an open position; expelling fuel through a gap defined between the second portion of the nozzle assembly and the housing, wherein the gap is sized to restrict fuel flow and create a laminar flow output stream having a Reynolds Number of equal to or less than 2000. The method may further include the step of returning the nozzle assembly to the closed position.

### TECHNICAL FIELD

The disclosure relates to engine fuel systems and fuel injectors, and more particularly to a method for producing laminar flow through a fuel injection nozzle and expelling a laminar output stream therefrom.

### BACKGROUND

Various methods have been used to produce a laminar stream of fluid by reducing turbulence in a supply stream prior to discharge from a nozzle outlet. In order to achieve laminar flow, the Reynolds number associated with the fluid flow path must be less than or equal to approximately 2000. The Reynolds number is a dimensionless value that gives a measure of the ratio of inertial forces to viscous forces for given flow conditions, indicating whether flow in a particular application may be laminar or turbulent.

The relationship between the Reynolds number and the velocity of the stream, the diameter of the flow, and the kinematic viscosity of the fluid is dictated by the following equation:

Re=ρvG/μ

### Wherein:

### Re=Reynolds Number

ρ=density kg/m³
v=velocity of the stream (m/s)
G=gap or diameter of the flow area (m)
μ=dynamic viscosity (kg/m s).

The Reynolds number generally varies linearly with variable G. Generally a Reynolds number of less than or equal to 2000 indicates laminar flow, and a Reynolds number greater than 2000 indicates turbulent flow.

Typical fuel injection nozzles may have one or more spray holes or gaps with a diameter of from about 90 microns to about 100 microns or greater. As such, these nozzles produce turbulent fluid flow through the nozzle having a Reynolds number that may fall in the range of from about 10,000 to about 60,000, which are well within the range indicating turbulent flow.

### SUMMARY

A method of producing laminar flow through a fuel injection nozzle and expelling a laminar outlet stream therefrom is provided. The method comprises the steps of: providing a housing defining a cavity; providing a nozzle assembly having a first portion and a second portion extending from the first portion, the nozzle assembly being disposed within the cavity; placing the nozzle assembly in a closed position wherein the nozzle assembly is engaged with a valve seat defined by the housing, to prevent fuel from flowing through the cavity; displacing the nozzle assembly and moving the nozzle assembly to an open position, to allow fuel to flow through the cavity; and expelling fuel through a gap defined between the second portion of the nozzle assembly and the housing, wherein the gap is sized to restrict fuel flow and create a laminar flow output stream. The method may additionally include the step of returning the nozzle to the closed position.

A vehicle comprising an engine assembly including a combustion chamber; a direct injection fuel system in provided. The direct injection fuel system may include at least one fuel injector configured to inject fuel into the combustion chamber, the fuel injector having a housing and a nozzle assembly, the housing defining a cavity that extends longitudinally through the housing, the nozzle assembly disposed within the cavity; a fuel pump configured to supply the fuel injector with pressurized fuel; and at least one control module. The control module may be configured for placing the nozzle assembly in a closed position wherein the nozzle assembly is engaged with a valve seat defined by the housing, to prevent fuel from flowing through the cavity; displacing the nozzle assembly and moving the nozzle assembly to an open position, to allow fuel to flow through the cavity; expelling fuel through a gap defined between the second portion of the nozzle assembly and the housing, wherein the gap is sized to restrict fuel flow and create a laminar flow output stream.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic partial cross-sectional view of an engine assembly.

FIG. 2A is a schematic partial cross-sectional view of an example pintle nozzle in the closed position.

FIG. 2B is a schematic partial cross-sectional view of an example pintle nozzle in the open position, with a gap G or diameter of flow area sized to produce laminar flow.

FIG. 3A is a schematic partial cross-sectional view of an example poppet nozzle in the closed position.

FIG. 3B is a schematic partial cross-sectional view of an example poppet nozzle in the open position, with a gap G or diameter of flow area sized to produce laminar flow.

### DETAILED DESCRIPTION

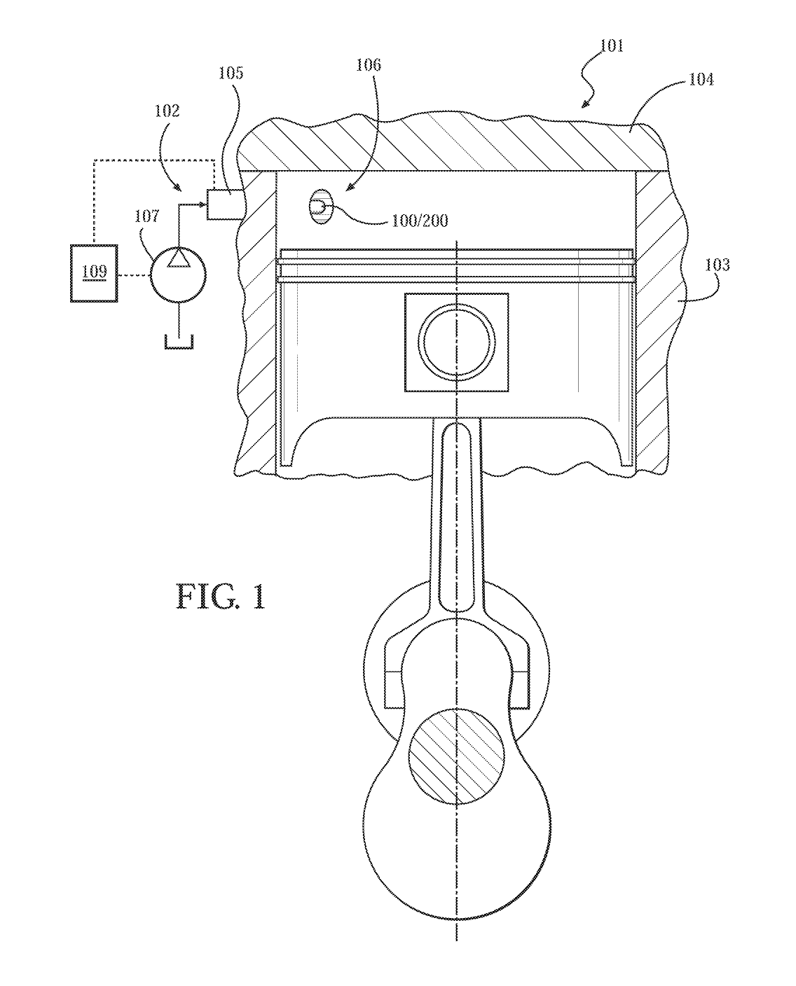

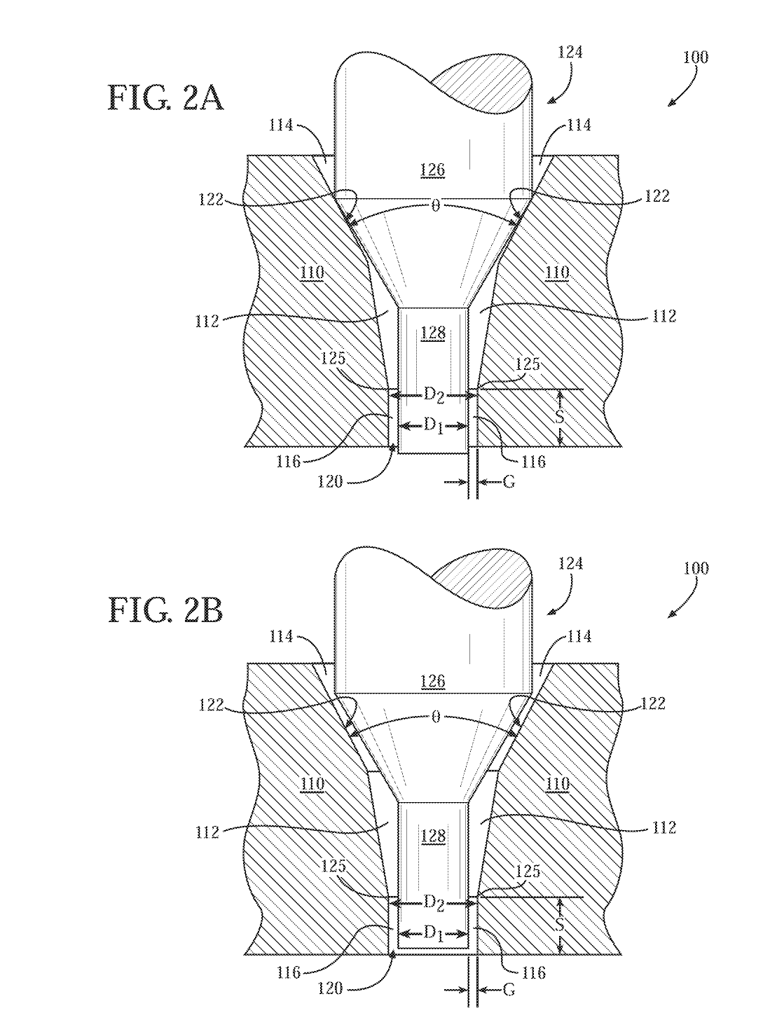

Referring to FIGS. 1, 2A-B, and 3A-B, wherein like reference numbers correspond to like or similar components throughout the several views, a method of producing laminar flow through a fuel injection nozzle 100, 200 and expelling a laminar outlet stream therefrom is provided.

The method of producing laminar flow through a fuel injection nozzle comprises the steps of: providing a housing 110, 210 defining a cavity 112, 212; providing a nozzle assembly 124, 224 having a first portion 126, 226 and a second portion 128, 228 extending from the first portion 126, 226, the nozzle assembly 124, 224 being disposed within the cavity 112, 212; placing the nozzle assembly 124, 224 in a closed position wherein the nozzle assembly 124, 224 is engaged with a valve seat 122, 222 defined by the housing 110, 210, to prevent fuel from flowing through the cavity 112, 212; displacing the nozzle assembly 124, 224 and moving the nozzle assembly 124, 224 to an open position, to allow fuel to flow through the cavity 112, 212; expelling fuel through a gap G defined between the second portion 128, 228 of the nozzle assembly 124, 224 and the housing 110, 210, wherein the gap G is sized to restrict fuel flow and create a laminar flow output stream. The method may additionally include the step of returning the nozzle assembly 124, 224 to the closed position.

The fuel injection nozzle 100, 200 may be incorporated into an engine assembly 101, as shown in FIG. 1. The engine assembly 101 may include an engine in communication with a direct injection fuel system 102. The direct injection fuel system 102 may be controlled by at least one control module 109. The engine assembly 101 may also include, but is not limited to, an engine block 103 and cylinder head 104. The engine block 103 and cylinder head 104 cooperate to define a combustion chamber 106.

The direct injection fuel system 102 may include a fuel pump 107 and plurality of fuel injectors 105, controlled by the at least one control module 109, in fluid communication with the combustion chamber 106. The fuel pump 107 may provide the plurality of fuel injectors 105 with pressurized fuel.

Each of the fuel injectors 105 may inject a stream of fuel, i.e. fuel spray, into the combustion chamber 106 through a fuel injection nozzle 100, 200. Each of the plurality of fuel injectors 105 may include a housing 110, 210 defining a cavity 112, 212 that extends longitudinally through the housing 110, 210. The cavity 112, 212 may be composed of a longitudinal bore 114, 214 and an outlet 116, 216.

The fuel spray is injected into the combustion chamber 106 along a linear path. While it should be appreciated that the injected fuel spray may fan out over a distance to define a plume of injected fuel spray (i.e. output stream break up), a centerline of the plume extends along a straight, non-curving, linear path. Once injected into the combustion chamber 106, the fuel spray may mix with combustion air to form a fuel/air mix.

Each of the plurality of fuel injectors 105 may include a fuel injection nozzle 100, 200. A fuel injection nozzle 100, 200, which produces a laminar flow output stream allows the fuel to be injected directly from the fuel injection nozzle 100, 200 into the combustion chamber 106 to provide high velocity sprays having delayed output stream break-up and longer spray penetration lengths with deep penetration into the combustion chamber 106. Each of these spray characteristics of laminar flow output facilitate enhanced fuel and air mixing, reduce smoke, and improve fuel consumption in direct injection engines.

In one configuration, shown in FIGS. 2A-2B, the fuel injection nozzle 100 may be a pintle-type fuel injection nozzle with variable area, and may include a nozzle assembly 124. The nozzle assembly 124 may include a first portion 126 and a second portion 128 extending from the first portion 126, the second portion 128 having a diameter D₁. The nozzle assembly 124 may be disposed within the cavity 112, the first portion 126 disposed within the longitudinal bore 114 and the second portion 128 disposed within the outlet 116.

The housing 110 may define a cavity 112 that extends longitudinally through the housing 110. The cavity 112, 212 may be composed of a longitudinal bore 114 and an outlet 116. The outlet 116 may have a diameter D₂.

The housing 110 may further define a pintle valve seat 122. The pintle valve seat 122 may be defined so as to delineate the transition within the cavity 112 from the longitudinal bore 114 and to the outlet 116. The pintle valve seat 122 may have a seat angle of θ, which may range from ninety to one-hundred and eighty degrees.

Pressurized fuel may be supplied to the longitudinal bore 114 through the plurality of fuel injectors 105 of the direct fuel injection system 102 and exit the fuel injection nozzle 100 at the outlet 116 expulsion point 120.

The difference in diameter D₂ of the outlet 116 and the diameter D₁ of the first portion 126 of the nozzle assembly 124 defines at least one gap G, on either side of the second portion 128 of the nozzle assembly 124. The gap G defined by and disposed between the second portion 128 and the housing 110. The gap G may be an annular or ring-shaped gap.

In FIG. 2A the pintle nozzle assembly 124 is in a closed position, and in FIG. 2B the pintle nozzle assembly 224 is in an open position. The fuel injection nozzle 100, being a variable area nozzle, may also occupy a position between the closed position and the fully open position.

In FIG. 2A the nozzle assembly 124 is shown in the closed position, wherein the first portion 126 of the nozzle assembly 124 is engaged with the pintle valve seat 122. In the first position, the coupling of the first portion 126 and pintle valve seat 122 blocks the fuel passage from the longitudinal bore 114 to the outlet 116, thereby preventing any fuel from exiting the gap G and preventing any discharge of fuel into the combustion chamber 106.

In FIG. 2B the pintle-type nozzle is in the open position, wherein the first portion 126 of the nozzle assembly 124 is linearly displaced and disengaged from contact with the pintle valve seat 122 by at least one control module 109. In the open position, fuel is allowed to pass from the longitudinal bore 114 to the outlet 116. In the open position, fuel is allowed to exit the gap G and thereby be discharged into the combustion chamber 106.

The second portion 128 of the nozzle assembly 124 is designed to have a substantially constant diameter D₁. Additionally, the outlet 116 is designed to have a substantially constant diameter D₂, which is greater than that of D₁. The difference in diameter D₁ of the second portion 128 and the diameter D₂ of the outlet 116 creates the gap G. The gap G remains constant upon a movement of the nozzle assembly 124 from the closed position to the open position. The linear distance S the between the closed position and the open position is confined between the expulsion point 120 and a critical point 125. The critical point 125 may be defined by a change in outlet diameter D₂.

By confining the linear movement of the nozzle assembly 124, the size gap G remains constant, and is sized so as to produce laminar flow and expel a laminar flow outlet stream.

Allowing for the production of laminar flow with an Rₑ of 2000 or less through the gap G, the values of the Reynolds number equation may be constrained by the following ranges: a velocity of from about 200 msec to about 550 msec; an injection pressure of from about 30 MPa to about 200 MPa; and the dynamic viscosity of fuel being approximately 1.2 cP.

In a first example wherein the velocity is approximately 550 m/sec and the injection pressure is about 200 MPa, the gap G may be up to approximately 2.5 microns, producing a laminar flow outlet stream exhibiting a Rₑ of 2000 or less. In a second example wherein the velocity is approximately 200 m/sec and the injection pressure if about 30 MPa, the gap G may be approximately 6.5 microns, producing a laminar flow outlet stream exhibiting a Rₑ of 2000 or less.

In a third example, a pintle-type fuel injection nozzle 100, initially in the closed position with no flow through gap G, may be placed in the open position with a gap G of approximately 2 microns. The output stream of this example exhibits laminar flow at an exit flow velocity of approximately 400 m/sec resulting in a deep penetrating spray with an Rₑ of about 1120.

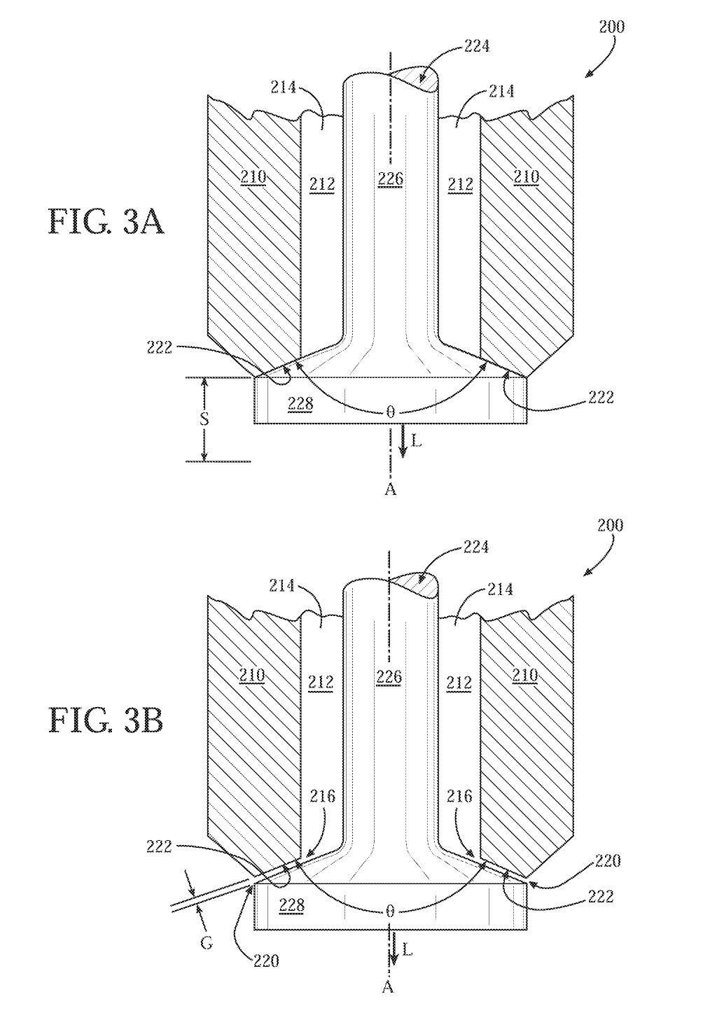

In another configuration, shown in FIGS. 3A-3B, the fuel injection nozzle 200 may be a poppet-type fuel injection nozzle with variable area. The variable area poppet-type fuel injection nozzle 200 may include a nozzle assembly 224. The nozzle assembly 224 may include a first portion 226 and a second portion 228. The second portion 228 may extend from the first portion 226.

The housing 210 may define a cavity 212 that extends longitudinally through the housing 210. The cavity 212 may include a longitudinal bore 214 and an outlet 216. The nozzle assembly 224 may be disposed within the cavity 212 defined by the housing 210, the first portion 226 disposed within the longitudinal bore 214 and the second portion disposed within the outlet 216. The housing 210 may further define a poppet valve seat 222. The poppet valve seat 222 may be defined so as to delineate the transition within the cavity 212 from the longitudinal bore 214 and to the outlet 216. The poppet valve seat 222 may have a seat angle of θ, which range from about 90 to about one hundred and eighty degrees.

Pressurized fuel may be supplied to the longitudinal bore 214 through the plurality of fuel injectors 105 of the direct fuel injection system 102 and exit the fuel injection nozzle 200 at the expulsion point 220.

The distance created between the poppet valve seat 222 and the second portion 228 when the poppet nozzle assembly 224 is transitioned from the closed position to the open position defines the gap G, on either side of second portion 228 of the poppet nozzle assembly 224. The gap G defined by and disposed between the second portion 228 and the housing 210.

In FIG. 3A the poppet nozzle assembly 224 is in the closed position, and in FIG. 3B the poppet nozzle assembly 224 is in the open position. The fuel injection nozzle 200, being a variable area nozzle, may also occupy a position between the closed position and the fully open position.

In the closed position, shown in FIG. 3A, the second portion 228 may engage the poppet valve seat 222 to seal the outlet 216 from the longitudinal bore 214 and block the fuel passage from the longitudinal bore 214 to the outlet 216, thereby preventing any fuel from exiting the at least one gap G at the expulsion point 220.

In the open position, shown in FIG. 3B the poppet-type fuel injection nozzle 200 is in the open position, wherein the second portion 228 is longitudinally displaced along axis A and disengaged from the poppet valve seat 222, by at least one control module 109. In the open position, fuel is allowed to pass from the longitudinal bore 214 to the outlet 216 through the gap G defined by and disposed between the second portion 228 and the housing 210.

As the second portion 228 is longitudinally displaced along axis A between the closed position and the open position, the gap G is formed. The gap G becomes larger as the poppet nozzle assembly 224 is moved from the closed position to the open position in direction L. The linear distance S between the closed position and the open position is confined by a critical point (not shown) at which the gap G approaches a width which does not allow for laminar flow, thereby producing a Rₑ of greater than 2000 with respect to the corresponding values of injection pressure, exit velocity, and dynamic viscosity.

Allowing for the production of laminar flow with an Rₑ of 2000 or less through the gap G, the values of the Reynolds number equation may be constrained by the following ranges: a velocity of from about 200 msec to about 550 msec; an injection pressure of from about 30 MPa to about 200 MPa; and the dynamic viscosity of fuel being approximately 1.2 cP.

In an example wherein the velocity is approximately 550 m/sec and the injection pressure is about 200 MPa, the gap G may be up to approximately 2.5 microns. In an example wherein the velocity is approximately 200 m/sec and the injection pressure if about 30 MPa, the gap G may be up to approximately 6.5 microns. Each of the aforementioned examples may produce a laminar flow output stream, resulting in a deep penetrating spray and a laminar flow output with an Rₑ of less than 2000.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of producing laminar flow through a fuel injection nozzle comprising the steps of:
providing a housing defining a cavity;
providing a nozzle assembly having a first portion and a second portion extending from the first portion, the nozzle assembly being disposed within the cavity;
placing the nozzle assembly in a closed position wherein the nozzle assembly is engaged with a valve seat defined by the housing, to prevent fuel from flowing through the cavity;
displacing the nozzle assembly and moving the nozzle assembly to an open position, to allow fuel to flow through the cavity;
expelling fuel through a gap defined between the second portion of the nozzle assembly and the housing, wherein the gap is sized to restrict fuel flow and create a laminar flow output stream.

2. The method of claim 1 wherein the method further includes returning the nozzle assembly to the closed position.

3. The method of claim 1 wherein the gap is an annular gap.

4. The method of claim 1 wherein the nozzle is a pintle-type nozzle.

5. The method of claim 4 wherein the pintle-type nozzle is of variable area.

6. The method of claim 1 wherein the nozzle is a poppet-type nozzle.

7. The method of claim 6 wherein the poppet-type nozzle is of variable area.

8. The method of claim 1 wherein the fuel is expelled from the gap at a velocity of from about 200 m/s to about 550 m/s.

9. The method of claim 1 wherein the fuel injection nozzle operates at an injection pressure of from about 30 MPa to about 200 MPa.

10. The method of claim 1 wherein the fuel injection nozzle operates at an injection pressure of 30 MPa and wherein fuel is expelled from the gap at a velocity of 200 m/s.

11. The method of claim 10 wherein the gap is approximately 6.5 microns or less.

12. The method of claim 1 wherein the fuel injection nozzle operates at an injection pressure of 200 MPa and wherein fuel is expelled from the gap at a velocity of 550 m/s.

13. The method of claim 12 wherein the gap is approximately 2.5 microns or less.

14. A vehicle comprising:
an engine assembly including a combustion chamber;
a direct injection fuel system including:
at least one fuel injector configured to inject fuel into the combustion chamber, each of the at least one fuel injector having a housing and a nozzle assembly, the housing defining a cavity that extends longitudinally through the housing, the nozzle assembly disposed within the cavity;
a fuel pump configured to supply the at least one fuel injector with pressurized fuel;
at least one control module wherein the control module is configured for:
placing the nozzle assembly in a closed position wherein the nozzle assembly is engaged with a valve seat defined by the housing, to prevent fuel from flowing through the cavity;
displacing the nozzle assembly and moving the nozzle assembly to an open position, to allow fuel to flow through the cavity;
expelling fuel through a gap defined between the second portion of the nozzle assembly and the housing, wherein the gap is sized to restrict fuel flow and create a laminar flow output stream.

15. The vehicle of claim 14 wherein the at least one control module is further configured for returning the nozzle assembly to the closed position.
